(19) United States
(12) Patent Application Publication
(10) Pub. No.: US 2024/0361452 A1
(43) Pub. Date: Oct. 31, 2024

(54) INSTALLATION ARRANGEMENT, ULTRASONIC JAM SWITCH THEREFOR, AND THE USE THEREOF AND OPERATING METHOD

(71) Applicant: Microsonic GmbH, Dortmund (DE)

(72) Inventors: Johannes SCHULTE, Dortmund (DE); Jens HERGET, Dortmund (DE)

(73) Assignee: Microsonic GmbH, Dortmund (DE)

(21) Appl. No.: 18/766,342

(22) Filed: Jul. 8, 2024

Related U.S. Application Data
(63) Continuation of application No. PCT/DE2022/100969, filed on Dec. 19, 2022.

(30) Foreign Application Priority Data
Jan. 7, 2022 (DE) 10 2022 000 053.9

(51) Int. Cl. G01S 15/88; B65G 43/08; G10K 11/28

(52) U.S. Cl. CPC G01S 15/88; B65G 43/08; G10K 11/28; B65G 2201/0244

(57) ABSTRACT

A jam switch to identify a jam of containers, more particularly bottles, transported on a conveyor of a conveyor mechanism, comprising an ultrasonic sensor. The ultrasonic sensor transmitting an ultrasonic signal and receiving an echo signal reflected back by a container present in a detection region of the jam switch. A reflector with a sound-deflecting sound deflection surface is disposed upstream of an aperture which is part of the ultrasonic sensor and which emits the sound lobe. The sound deflection surface being shaped and arranged such that the sound lobe emitted by the ultrasonic sensor is deflected in such a way at the sound deflection surface that the sound lobe, in relation to the sensor axis, is expanded with a divergence angle of 90° to 180° in a first plane and is unchanged or even more sharply focused in a second plane aligned at right angles to the first plane.

This nonprovisional application is a continuation of International Application No. PCT/DE2022/100969, which was filed on Dec. 19, 2022, and which claims priority to German Patent Application No. 10 2022 0000 053.9, which was filed in Germany on Jan. 7, 2022, and which are both herein incorporated by reference.

### BACKGROUND OF THE INVENTION

### Field of the Invention

The invention relates to a jam switch for identifying containers, in particular bottles, that are jammed on conveyor systems. The invention further relates to an installation arrangement with a jam switch and use thereof, and to an operating method for same.

### Description of the Background Art

In the beverage and filling industry, in which containers such as bottles, for example, are filled with beverages, these containers in the empty as well as the filled state are transported on a conveyor system using a conveying device, in particular a conveyor belt. The conveyor belt may have an overall width in the range of 200 mm to 1000 mm, for example. Lateral railings prevent the containers from falling from the conveyor belt. The containers may initially be present on the conveyor belt in a scattered, chaotic distribution (FIGS. 8, 9). This container flow consolidates upon further transport on the conveyor belt. The conveyor system is divided into jam sections. The conveyor belt that is continuously moving in a conveying direction transports the containers to a transfer point. On the way the containers become jammed, so that the conveyor belt is filled with containers over its entire width. Mounted on the side of one of the railings of the conveyor belt are so-called jam switches that emit a signal when the containers have become jammed in this region (FIGS. 10, 11). The jam switches known on the market are generally mechanical jam switches 27 made up of a mechanical bracket 21 that is oriented in parallel to the railing 20 or to the conveying direction F of the conveying device 24 or the conveyor belt (FIGS. 8 through 11). This bracket is rigidly connected to a swivelable rocker arm 22, so that the jammed containers may press the bracket outwardly, i.e., away from the conveyor belt, approximately 20 mm to 30 mm. Situated at the rocker arm is a metal tab that may be queried by an inductive proximity switch. A mechanical jam switch of this type is disclosed in DE 10 2010 000 596 A1.

If the containers now become jammed in the region of this bracket, the containers press the bracket of the mechanical jam switch outwardly, and via the rocker arm the metal tab is moved into the detection range of an inductive proximity switch of the mechanical jam switch. An initiator is triggered and outputs a switching signal at the output of the mechanical jam switch. A controller of the conveyor system that is operatively connected to the mechanical jam switch thus obtains a signal that a container jam has occurred in this region of the conveying device. These mechanical jam switches, with a rocker arm and its movable parts, have a complex design and are very susceptible to malfunctions, and require regular maintenance.

### SUMMARY OF THE INVENTION

It is therefore an object of the invention, to provide a low-maintenance jam switch for identifying containers, in particular bottles, that are jammed on conveyor systems. The object is further achieved by an installation arrangement according to the invention, an operating method according to the invention, and use according to the invention.

The aim of the present invention is to replace the mechanical jam switches, which operate by touch, with a jam switch having a sensor that operates without contact. This must be a scanning sensor that is able to detect jammed containers, in particular bottles. Optical sensors are ruled out here, since containers and in particular bottles may be made of a highly transparent material, in particular highly transparent plastic or glass. It is difficult for optical sensors to reliably recognize containers made of such highly transparent materials.

For this purpose, it makes more sense to use an ultrasonic sensor with a switching output in which a defined switching distance is set. In principle, ultrasonic sensors are able to recognize all objects that reflect sound, and operate entirely independently of color, so that they can also reliably recognize objects, and in particular containers, made of highly transparent materials. These types of ultrasonic sensors operate according to echo propagation time measurement, and cyclically emit a brief ultrasonic pulse that propagates at the speed of sound in air. When the ultrasonic pulse strikes a container, in particular a bottle, the ultrasonic pulse is reflected, and as an echo signal (echo) arrives back at the ultrasonic sensor. Based on the propagation time between the emission of the ultrasonic pulse and receipt of the echo signal that is reflected back from the container to be detected, the ultrasonic sensor, using the speed of sound which is known to it, computes a measured distance from the container. If the container has fallen below a certain switching distance, the output is set. These ultrasonic sensors, also referred to as ultrasonic proximity switches, are widely used in industrial applications. It is part of the prior art that these industrially used ultrasonic proximity switches have a rotationally symmetrical, narrowly or sharply focused detection range. This is also referred to as a narrow sound field. This is generally also desirable, since the ultrasonic proximity switch is intended for recognizing individual objects or for measuring the filling level in a narrow tank. If the ultrasonic proximity switch is used, for example, for measuring the filling level in a small tank or small vessel, it is desirable to obtain a sound reflection only from the liquid surface, but not from the inner walls of the tank or the small vessel.

For the use as a jam switch, these rotationally symmetrical, sharply focused detection ranges of the ultrasonic sensors are desirable in a vertical plane extending perpendicularly with respect to the conveying direction of the conveying device, since the ultrasonic sensor is mounted on the outside, in front of or at the railing of the conveying device, and is to measure flatly across the conveying device, transversely with respect to its transport direction, since the conveying device itself must not be detected.

Since the containers, in particular bottles, to be detected have very different shapes and sizes, and therefore different container heights or bottle heights are transported, according to one installation arrangement according to the invention the jam switch according to the invention is preferably situated so that it measures just above the conveying device or the conveyor belt (see FIGS. 12 through 14). This has the advantage that the jam switch is able to scan all container sizes without the mounting position of the jam switch having to be adjusted with each format change of the containers. In contrast, in a horizontal plane parallel to the conveying direction of the conveyor belt, the rotationally symmetrical, sharply focused detection range of the ultrasonic sensor is a drawback, since a container being transported on the conveying device can be reliably recognized by the ultrasonic sensor only when the container is situated essentially in the center of the detection range of the ultrasonic sensor.

Since most containers, in particular bottles, have a circular cross section, the sound is reflected away from them very quickly as soon as the container is situated slightly to the left or the right outside the central beam of the ultrasonic sensor.

Since a sharply focused ultrasonic sensor, as a jam switch, measures transversely with respect to the conveying direction of the conveying device, as soon as a container enters the detection range of the ultrasonic sensor, most of the time the sound is reflected laterally away from the container. If this laterally reflected sound pulse strikes a neighboring container during a container jam on the conveying device, the sound pulse is re-reflected, and as an echo may possibly reflect back in the direction of the ultrasonic sensor. However, since the ultrasonic sensor has a rotationally symmetrical, sharply focused detection range, it cannot receive this echo.

Therefore, the subject matter of the present invention relates to a jam switch having an ultrasonic sensor such that the detection range of the ultrasonic sensor in the vertical plane (second plane), perpendicular to the conveying direction of the conveyor belt, is still sharply focused so that the ultrasonic sensor does not receive any interfering reflections from the conveying device, and the detection range in the horizontal plane (first plane), parallel to the conveying direction of the conveyor belt, is so greatly spread that the ultrasonic sensor still receives a direct echo from a container, in particular a bottle, even when the container or bottle is situated outside the central beam of the ultrasonic sensor, and/or that the ultrasonic sensor can detect an echo that is reflected back via a neighboring container.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus, are not limitive of the present invention, and wherein:

FIG. 1 illustrates a sound deflection surface;

FIG. 2 illustrates a deflection of a circular cone-shaped surface;

FIG. 3 illustrates an example for the sound deflection surface of the jam switch according to the invention;

FIG. 4 illustrates a deflection of the beam vectors;

FIG. 5 illustrates a sound deflection surface;

FIG. 6 illustrates a sound deflection surface of the jam switch;

FIG. 7 illustrates a sound deflection surface f the jam switch;

FIG. 8 illustrates a jam switch on a conveying device;

FIG. 9 illustrates a jam switch on a conveying device;

FIG. 10 illustrates a jam switch on a conveying device;

FIG. 11 illustrates a jam switch on a conveying device;

FIG. 12 illustrates an installation arrangement according to an example;

FIG. 13 illustrates an installation arrangement according to an example;

FIG. 14 illustrates an installation arrangement according to an example;

FIG. 15 illustrates an installation arrangement according to an example;

FIG. 16 illustrates a characteristic profile of a measured distance of the jam switch; and

FIG. 17 illustrates a characteristic profile of a measured distance of the jam switch in an event of jamming;

### DETAILED DESCRIPTION

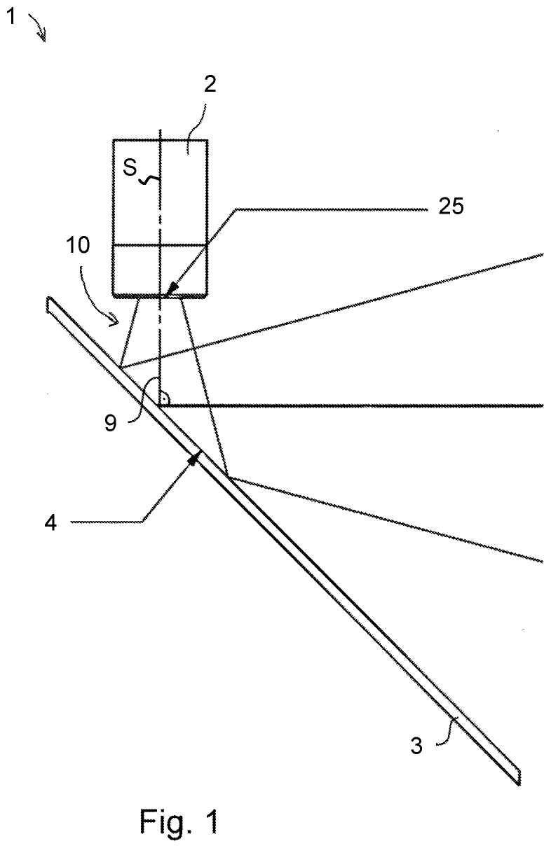

It is known that with a flat surface, the sound field of an ultrasonic sensor may be deflected about a defined angle essentially without loss. Thus, for ultrasonic sensors there are reflectors with sound deflection surfaces having a flat surface that is oriented at an inclination angle of 45° with respect to a sensor axis of the ultrasonic sensor or to the exiting sound field/sound lobe of the ultrasonic transducer, so that a central beam of the ultrasonic signal in alignment with the sensor axis, or of the sound lobe of the ultrasonic sensor, is deflected on same by 90° overall (FIG. 1). When the central beam strikes the sound deflection surface, the central beam is deflected according to the physical law that the angle of incidence=the angle of reflection (45° in each case). The sound field of an ultrasonic sensor becomes increasingly more divergent, so that all other imaginary vectors are correspondingly deflected.

The invention is based on the concept of designing such a sound deflection surface of a reflector in such a way that the sound lobe/the sound field of an ultrasonic sensor directed onto the sound deflection surface is (radially) spread out in a first plane, and is not spread out in a second plane oriented perpendicularly with respect to the first plane, or in the best case is even bundled. The first plane defines an extension of a detection range of the ultrasonic sensor with regard to the conveying direction of the conveying device, and the second plane defines an extension of the detection range of the ultrasonic sensor with regard to a height range above the conveying device.

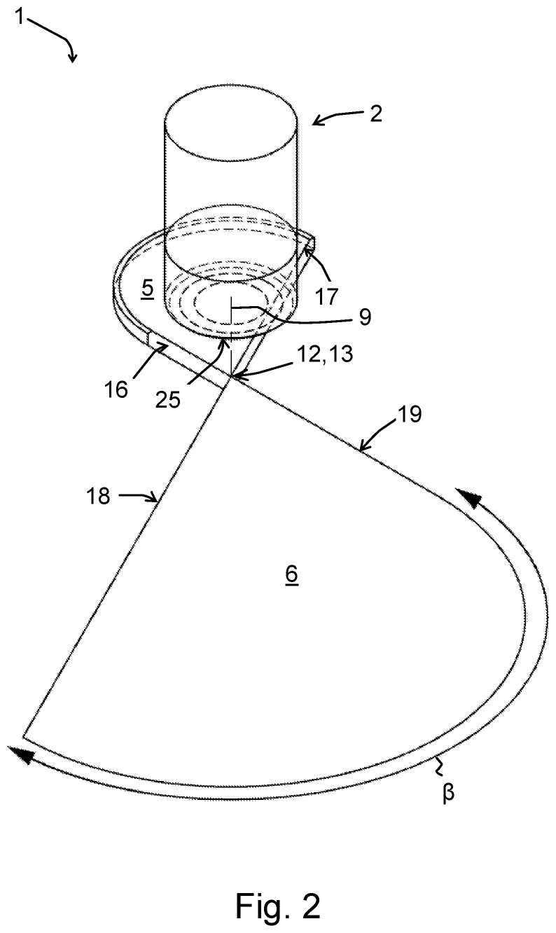

If a 45° sound deflection surface as illustrated in FIG. 1 is initially imagined as a two-dimensional planar plane in space, and then according to one refinement of the invention this planar plane curves around the central beam 9 of the ultrasonic sensor 2 in a defined angular range or rotational angle β of ±75° in space, for example, with the sensor axis S of the ultrasonic sensor as a rotational axis, this results in two surface regions of a circular cone-shaped surface (FIG. 2) with their apexes 12, 13 superposed, with the second surface region 6 of the circular cone-shaped surface, at the bottom in the figure, being convexly curved, and the first surface region 5 of the circular cone segment-shaped surface, at the top in the figure, being concavely curved. In this regard, two triangular, curved surface regions from the circumferential surface of circular cones are superposed with their mutually facing apexes, wherein the central beam 9 of the sound lobe of the ultrasonic sensor intersects a connection point of the apexes 12, 13 of the surface regions. As a result of this arrangement, the sound lobe 10 of the ultrasonic sensor is now spread apart/dispersed by the sound deflection surface at the convex and concave surface regions in the first plane, but in its second plane is radiated unchanged or with no further bundling.

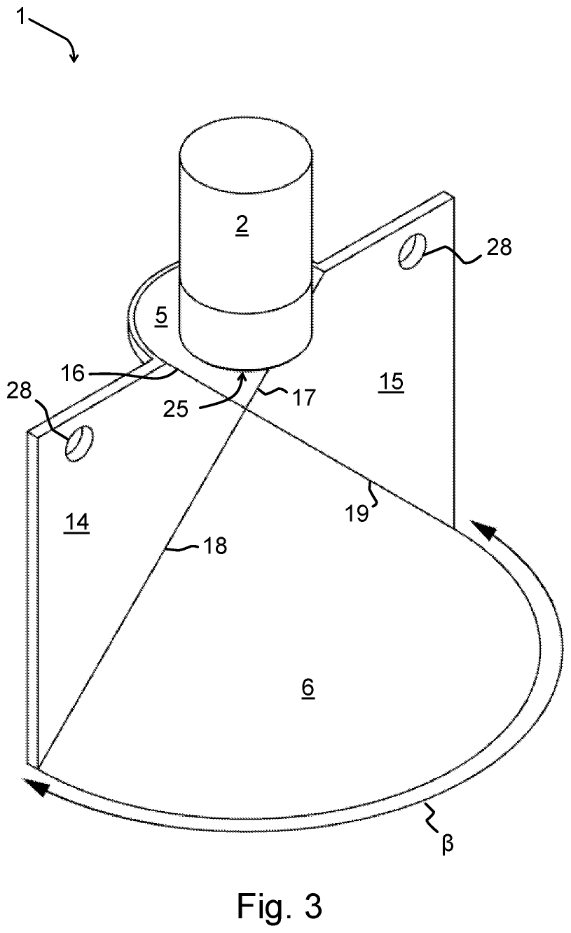

FIG. 3 indicates a further advantageous embodiment for the sound deflection surface 4 of the jam switch 1 according to the invention. In the present case, side edges 16, 17, 18, 19 of the curved surface regions 5, 6 that open into the apexes 12, 13 are joined together via flat reinforcement walls 14, 15. Mounting openings 28 for mounting the jam switch 1 are provided in the reinforcement walls 14, 15.

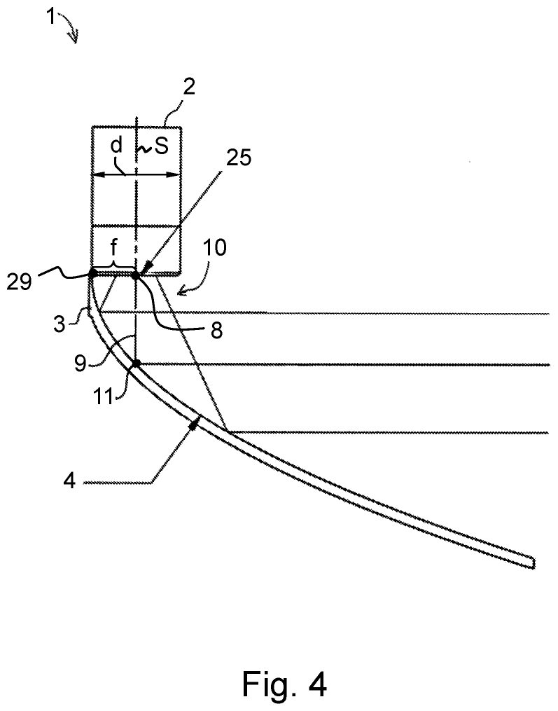

In one alternative embodiment of the invention, instead of a planar plane that is curved in space, the sound deflection surface is designed as a simply curved surface having a cross section in the shape of a half parabola (also referred to below as a parabola). The ultrasonic sensor is situated with respect to the sound deflection surface in such a way that an aperture 25 of the ultrasonic transducer that outputs the sound lobe, and the central beam 9 perpendicular thereto coincide with the focal point 8 of the parabola, and the central beam is deflected at the sound deflection surface 4 by 90° (with an angle of incidence and an angle of reflection of 45° in each case). All beam vectors of the divergent sound field are deflected in the sound deflection surface, and exit as a parallel beam (FIG. 4). The distance from the focal point 8 to a vertex 29 of the parabola is also referred to as the focal length f. In relation to the jam switch according to the invention, the focal length is oriented perpendicularly with respect to the central beam of the ultrasonic transducer, and intersects same at the focal point. The focal length f of the parabola-shaped sound deflection surface of the jam switch according to the invention should be selected to be large enough so that it corresponds at least to one-half the diameter d of the sound-radiating ultrasonic transducer (see FIG. 4).

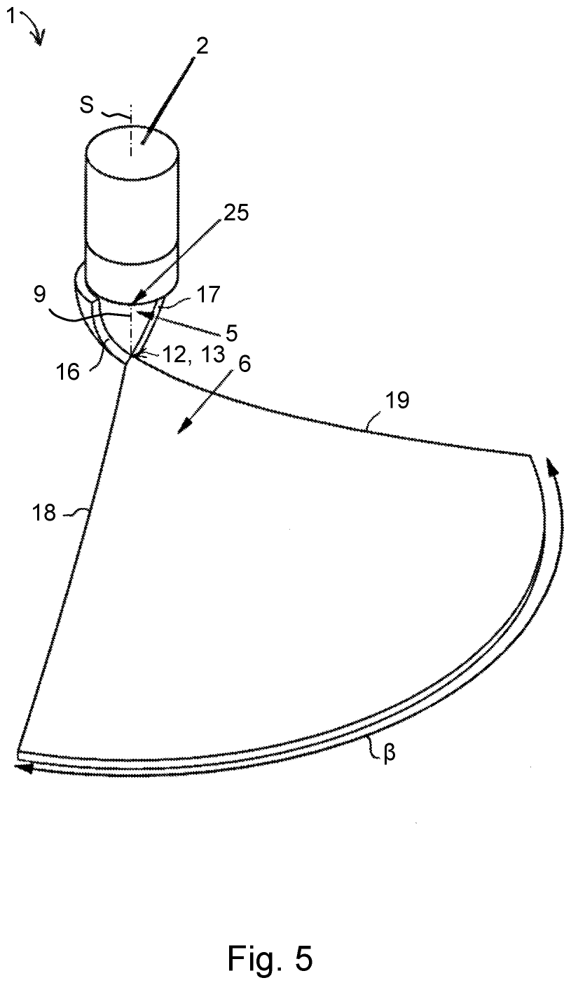

According to one refinement of the invention, this sound deflection surface having a parabola-shaped cross section is now curved about the axis of the central beam of the ultrasonic sensor, perpendicular to the sound-radiating sensor surface, by a certain magnitude of a rotational angle β, resulting in two parabolic surface regions 5, 6. A first surface region 5 above the impact point (projection focal point 11) of the central beam is concavely curved on the surface, and a second surface region 6 below the impact point is convexly curved (FIG. 5). The sound field or the sound lobe 10 of the ultrasonic sensor, which is directed onto such a parabolic surface as a sound deflection surface, is very sharply focused in the second plane (see FIG. 4), and in the first plane is spread apart or dispersed, as desired.

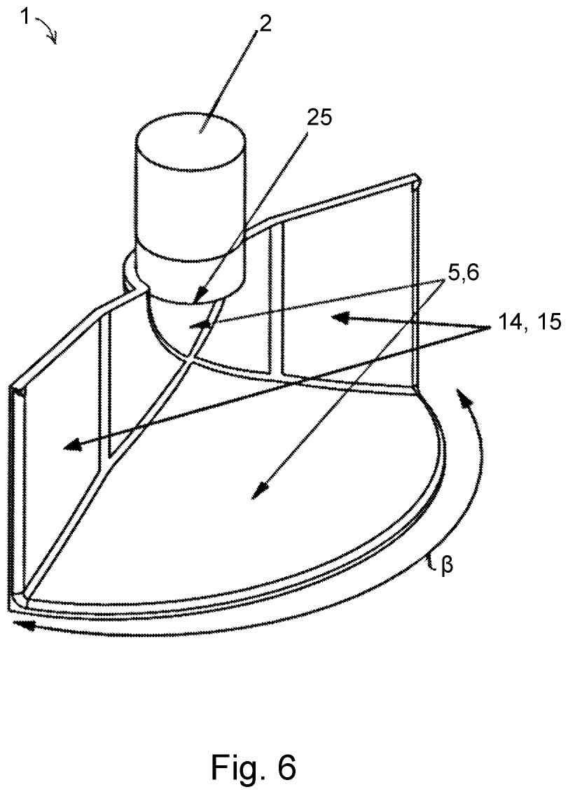

FIG. 6 shows a further advantageous embodiment for the sound deflection surface 4 of the jam switch according to the invention, with reinforcement walls 14, 15 on both sides which connect parabolically curved surface regions 5, 6 of the sound deflection surface at the side edges that open into the apexes, and in which mounting openings 28 for mounting the jam switch may also be provided in a further alternative embodiment.

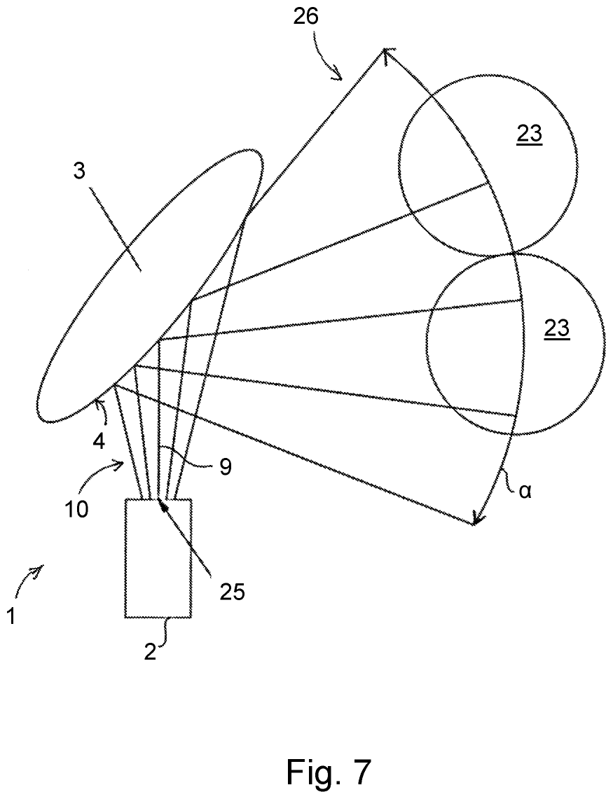

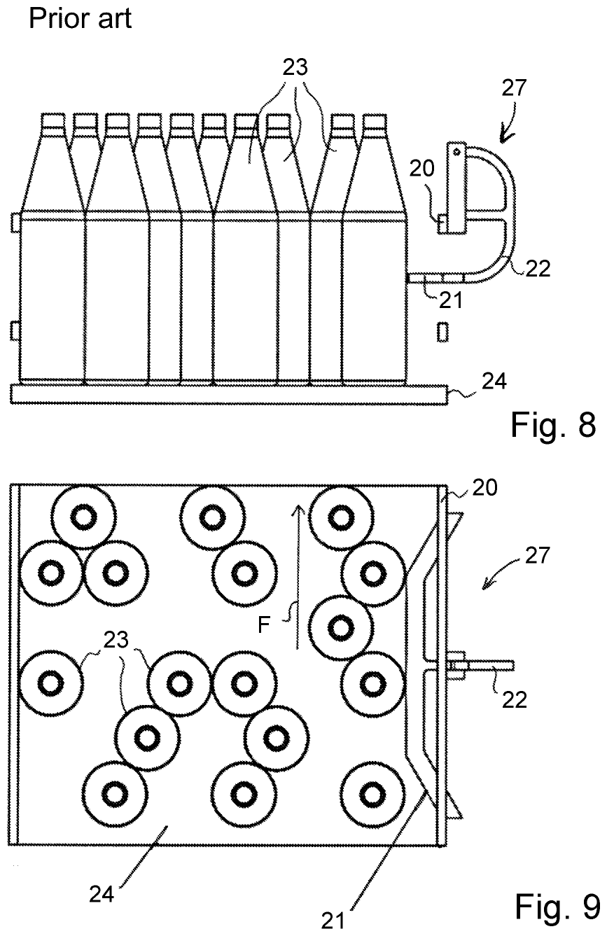

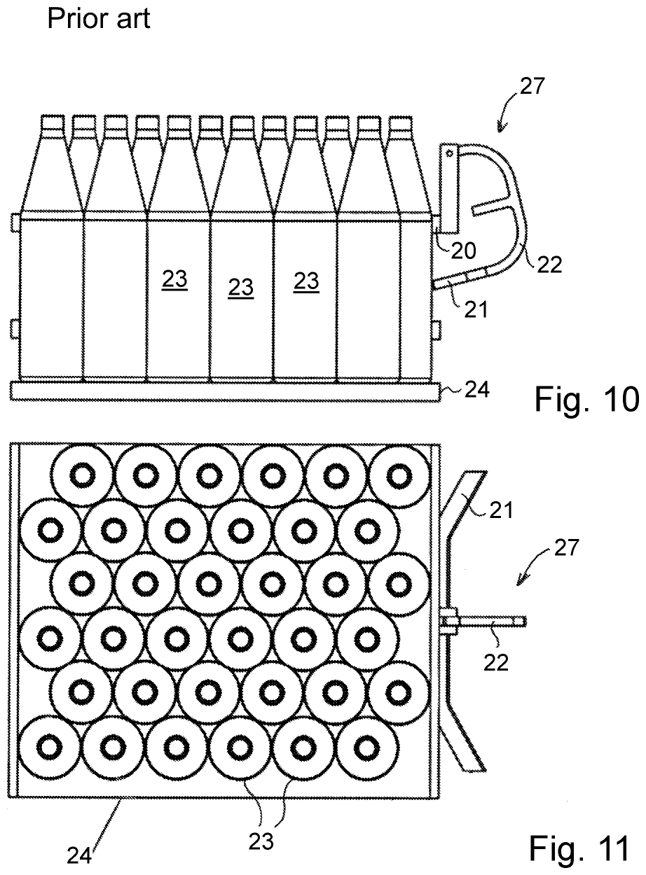

Of course, while maintaining the inventive concept, sound deflection surfaces for the jam switch are also conceivable which cause the sound field of the ultrasonic sensor to spread apart. In this regard, FIG. 7 shows a reflector 3 having an elliptically or convexly curved sound deflection surface 4 onto which a beam is horizontally directed by an ultrasonic sensor 2. Here as well, the sound field of the ultrasonic sensor is deflected in such a way that it exits in a spread-apart manner with a wide dispersion angle a, so that the detection range 26 of the ultrasonic sensor is expanded with regard to the conveying direction of the conveying device.

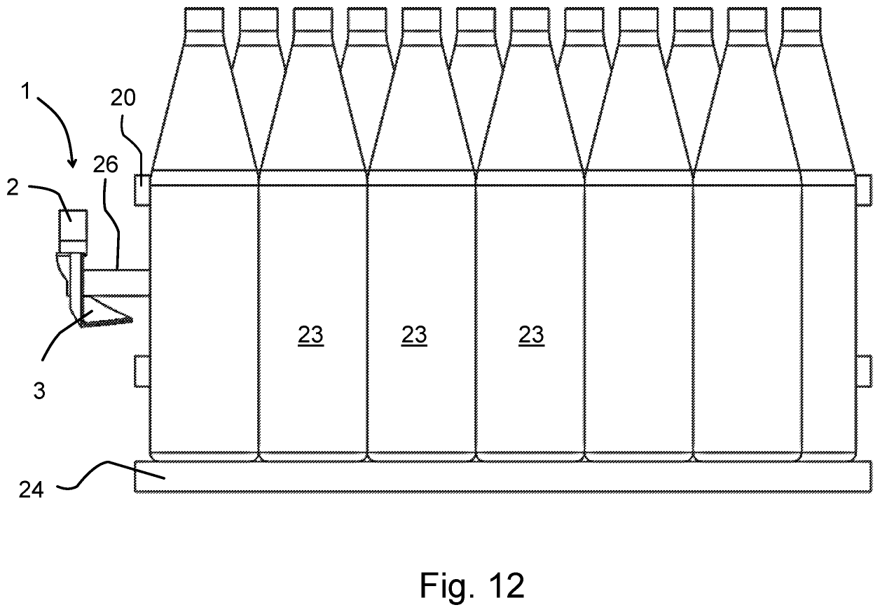

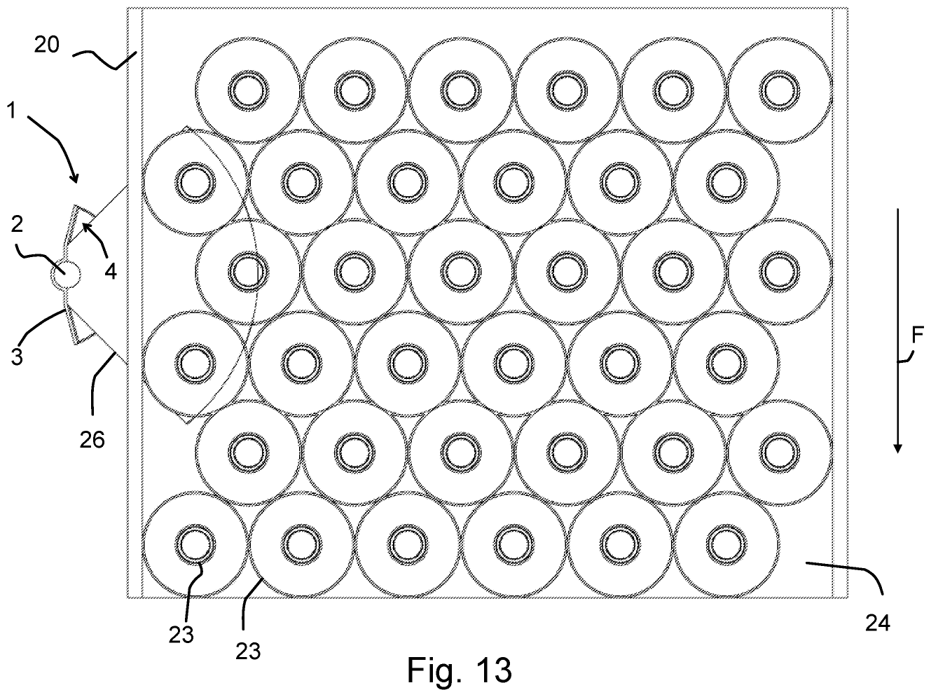

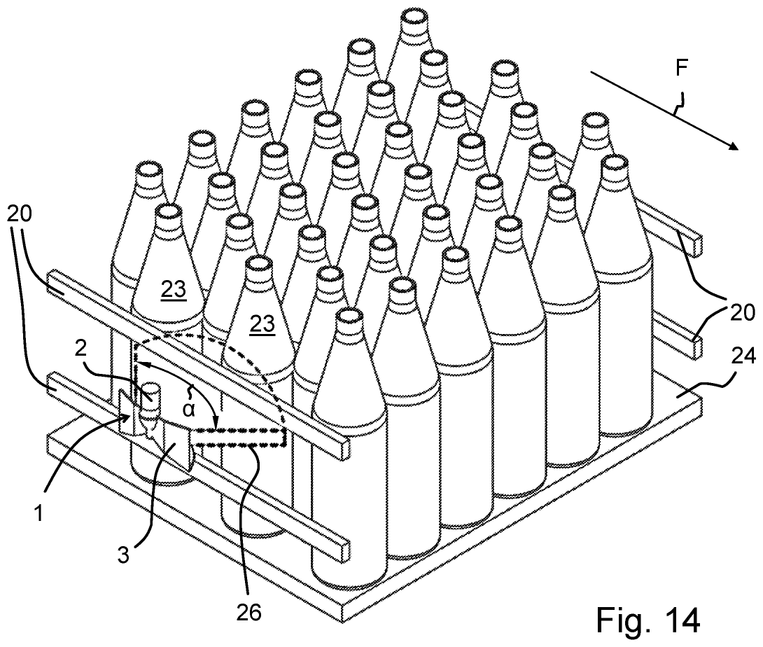

According to an installation arrangement according to the invention (see FIGS. 12 through 15), if an ultrasonic sensor 2 having a sound deflection surface 4 formed according to one of the above-mentioned embodiments is now laterally situated at or in front of the railing 20 of the conveying device 24, so that the sound field or the sound lobe 10 of the ultrasonic sensor 2 remains in the second plane perpendicular to the conveying direction, or is even bundled and widely fanned out in the first plane, a reflection from each container 23 situated within the broadly fanned-out sound field or detection range 26 may directly return to the ultrasonic sensor.

A mechanical jam switch 27 known from the prior art has a scanning range situated parallel to the railing 20. A switch path or a sensing range of the mechanical jam switch is typically 20 mm to 30 mm.

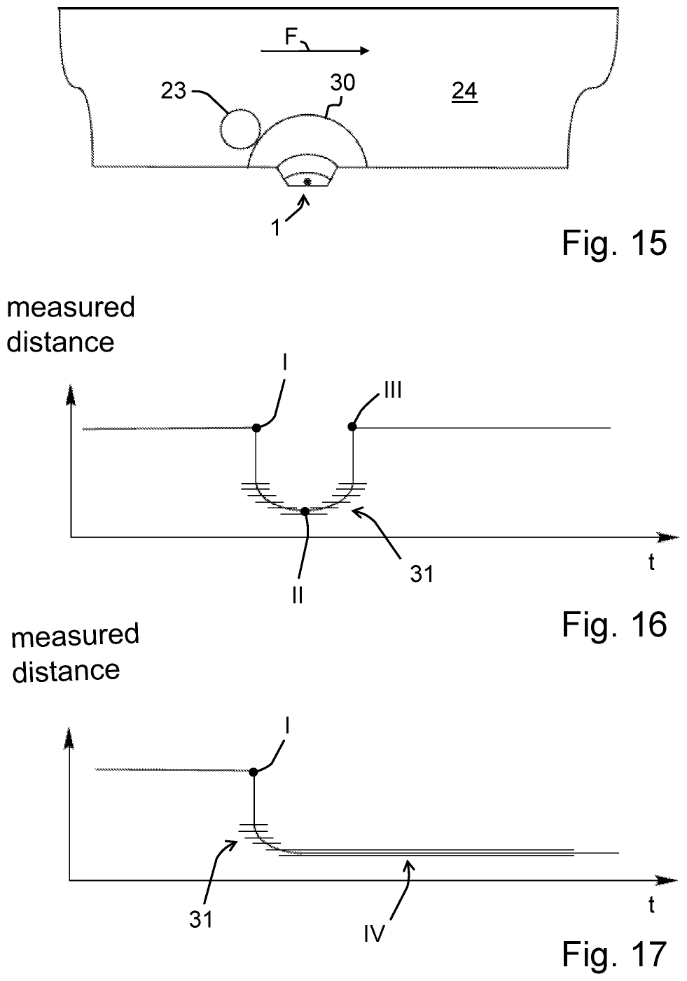

The jam switch 1 according to the invention, including the ultrasonic sensor 2 and the reflector 3 mounted in front of it, together with the characteristic sound deflection surface 4 as explained above, has a detection range 26 which, in comparison to a mechanical jam switch, has an at least similarly wide detection or scanning range and an at least comparably large switching distance or a comparably large sensing range with respect to the switching range of the mechanical jam switch, the switching distance 30 being radially formed (see FIG. 15).

The sound deflection surface of the reflector is preferably made of a solid material having a smooth surface which reflects or deflects the sound components essentially without loss.

Jamming of containers transported on the conveying device is characterized by the containers, in particular bottles, moving forward no further. A conventional ultrasonic proximity switch known from the prior art emits a switching signal when a container is situated within the detection range and the switching distance has fallen below a preset switching distance. In the known conventional ultrasonic proximity switch, this would mean that the ultrasonic proximity switch would deliver a switching signal even if a container was transported through the detection range of the ultrasonic sensor and the switching distance was fallen below. Therefore, further measures are necessary to allow a container that is in motion on the conveying device to be distinguished from a jammed container.

According to the invention, this is achieved in that the distance values that are measured by the jam switch 1 according to the invention and that are less than the preset switching distance 30 are observed for their variability. In this regard, FIG. 16 shows the characteristic profile of the measured distance of the jam switch 1 for a container 23 transported on the conveying device 24, over time t. When the container is transported alongside the jam switch 1, which operates transversely with respect to the conveying device, and is situated in the detection range 26 and the distance of the container from the ultrasonic sensor falls below the preset switching distance 30 of the jam switch, the container is initially detected with a larger measured distance (point I). The measured distance continuously decreases until the container is situated at the level of the central beam, in front of the ultrasonic sensor (point II). As the container is transported further, the measured distance from the jam switch once again increases until the container has finally left the detection range of the jam switch, and the distance of the container exceeds the switching distance of the jam switch (point III).

In contrast, in the event of jamming, the container remains for a longer period of time at the same position within the detection range of the jam switch. FIG. 17 shows one example of a characteristic profile of the measured distance over time t. The measured distance from the container does not change for the time of the jamming (area IV).

Therefore, the jam switch according to the invention continuously analyzes the profile of the measured distances for whether they leave a defined tolerance band 31 within a defined time period, or whether the measured distances continuously stay within this tolerance band over the defined time period. If an echo, once detected, leaves the tolerance band within the defined time period, the jam switch according to the invention assumes that the container is still in motion on the conveying device. If the measured distance remains within the tolerance band, as at point IV in FIG. 17, the jam switch assumes that the container at that moment is not in motion on the conveying device, and that jamming has occurred.

When the container is recognized for the first time by the jam switch and the measured distance from the container is less than the preset switching distance, the tolerance band is set around the measured distance. If the container is now further transported on the conveying device, the newly measured distance will leave the tolerance band, and a new tolerance band is set around the newly measured distance. This procedure is repeated as long as the newly measured distance leaves the tolerance band.

If a measured distance leaves the tolerance band at a given moment, the jam switch assumes that the position of the container on the conveying device has changed, i.e., that no jamming is present on the conveying device.

In contrast, if a distance, once detected, remains within its tolerance band for a defined minimum time period (see FIG. 17, point IV), the jam switch assumes that the container is no longer in motion, i.e., a container jam is present on the conveying device, and sets an output signal for the state “jam recognized.”

Further advantages, features, and particulars of the invention are apparent from the further subclaims. Features mentioned therein may in each case be essential to the invention, individually or in any given combination. Of course, features and details of the device described according to the invention also apply in conjunction with the installation arrangement according to the invention, the use according to the invention, and the operating method according to the invention, and vice versa. Thus, mutual reference may always be made to the disclosure concerning individual aspects of the invention. The drawings are used solely to clarify the invention, and are not limiting.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A jam switch to identify jamming of a container transported on a conveying device of a conveyor system, the jam switch comprising:
an ultrasonic sensor that emits a sound lobe that is sharply focused about a sensor axis, the ultrasonic sensor being designed as a proximity switch for transmitting an ultrasonic signal and receiving an echo signal reflected back by the container present in a detection range of the jam switch; and
a reflector with a sound-deflecting sound deflection surface arranged in front of an aperture of the ultrasonic sensor that emits the sound lobe, the sound deflection surface being shaped and arranged so that that the sound lobe emitted by the ultrasonic sensor is deflected at the sound deflection surface such that the sound lobe, in relation to the sensor axis, is spread with a divergence angle of 90° to 180° in a first plane and is unchanged or even more sharply focused in a second plane oriented substantially perpendicularly with respect to the first plane.

2. The jam switch according to claim 1, wherein the sound deflection surface of the reflector is inclined by 45° with respect to a central beam of the sound lobe that is emitted by the ultrasonic sensor, the central beam extending along the sensor axis.

3. The jam switch according to claim 1, wherein the sound deflection surface has two surface regions, a first surface region of the sound deflection surface being convexly shaped and a second surface region of the sound deflection surface being concavely shaped, the first surface region being situated at an axially greater distance, with respect to the sensor axis from the ultrasonic sensor than the second surface region.

4. The jam switch according to claim 1, wherein the sound deflection surface and/or the surface regions of the sound deflection surface has/have the shape of a section of a circumferential surface of a solid of revolution and/or of a sphere and/or an ellipsoid and/or a paraboloid and/or a hyperboloid and/or a cone.

5. The jam switch according to claim 3, wherein the surface regions of the sound deflection surface are formed by triangularly curved sections of a circumferential surface of a double cone made up of two cones with mutually opposed cone apexes, the double cone being formed by rotation by a rotational angle of a straight line, inclined by 45° with respect to the sensor axis as the rotational axis, about the sensor axis.

6. The jam switch according to claim 3, wherein the surface regions of the sound deflection surface are formed by triangularly curved sections of a circumferential surface of a solid of revolution, the solid of revolution being formed by rotation by a rotational angle of a half parabola about the sensor axis as the rotational axis, the sensor axis extending through a focal point of a parabola formed from the half parabola, and at the focal point being oriented substantially perpendicularly with respect to an axis of symmetry of the parabola, and the sensor axis intersecting the parabola at a projection focal point that is projected from the focal point onto the parabola.

7. The jam switch according to claim 6, wherein a focal length of the parabola, which along the axis of symmetry of the parabola corresponds to a distance from a vertex to the focal point of the parabola, is greater than or equal to one-half the diameter of the ultrasonic sensor.

8. The jam switch according to claim 5, wherein a magnitude of the rotational angle is 90° to 180° or is 150°.

9. The jam switch according to claim 5, wherein the triangularly curved surface regions of the sound deflection surface are joined together in the region of adjoining apexes arranged in alignment with the sensor axis.

10. The jam switch according to claim 3, wherein the sound deflection surface has lateral reinforcement walls, the reinforcement walls joining together side edges of the surface regions of the sound deflection surface that open into the adjoining apexes.

11. The jam switch according to claim 1, wherein the sound deflection surface of the reflector is made of a hard, smooth material or plastic.

12. An installation arrangement comprising:
a conveyor system with a conveying device, in particular a conveyor belt, including a container, in particular a bottle, that is transported on the conveying device in a conveying direction;
a jam switch according to claim 1, the jam switch being mounted at a railing of the conveying device, extending in parallel to the conveying direction, such that the sound lobe emitted by the ultrasonic sensor of the jam switch is deflected from the sound deflection surface of the reflector for the emission, mounted in front of the aperture of the ultrasonic sensor onto the container being transported on the conveying device so that in a first plane, which defines an extension of a detection range of the ultrasonic sensor with regard to the conveying direction, the sound lobe is radially spread out at a dispersion angle of 90° to 180°, and in a second plane that is oriented substantially perpendicularly with respect to the first plane and that defines an extension of the detection range of the ultrasonic sensor with regard to a height range above the conveying device, is unchanged or even more sharply focused.

13. The installation arrangement according to claim 12, wherein the sensor axis of the ultrasonic sensor is oriented substantially perpendicularly with respect to the conveying direction.

14. An operating method for a jam switch according to claim 1 for identifying jamming of containers, in particular bottles, transported on a conveying device of a conveyor system, the method comprising:
continuously ascertaining a propagation time between the emission of the ultrasonic signal by the ultrasonic sensor to a container to be detected and receipt of an echo signal that is reflected back from the container;
determining a measured distance of the ultrasonic sensor from the container to be detected from the ascertained propagation time;
determining if the measured distance falls below a preset switching distance and setting a tolerance band around a measuring signal for the measured distance;
setting an output signal for a state “jam recognized” if the measuring signal for the measured distance remains within the tolerance band over a defined time interval.

15. The jam switch according to claim 1, wherein the container includes a bottle.
